(19) United States
(12) Patent Application Publication
(10) Pub. No.: US 2016/0026632 A1
(43) Pub. Date: Jan. 28, 2016

(54) SENIORITY STANDARDIZATION MODEL

(71) Applicant: LinkedIn Corporation, Mountain View, CA (US)

(72) Inventors: Gloria Lau, Los Altos, CA (US); Vitaly Gordon, Mountain View, CA (US); Kin Fai Kan, Sunnyvale, CA (US)

(21) Appl. No.: 14/339,338

(22) Filed: Jul. 23, 2014

(51) Int. Cl. G06F 17/30; G06Q 10/10; H04L 29/08; G06Q 30/02

(52) U.S. Cl. CPC G06F 17/3053; G06F 17/30241; G06F 17/30864; G06F 17/30997; G06Q 30/0269; G06Q 10/1053; H04L 67/306; G06Q 50/01

(57) ABSTRACT

Method and system to infer seniority level of a social network member is provided. The system includes a transition data extractor, a token extractor, a transition data analyzer, and a storing module. The transition data extractor extracts transition data from member profiles maintained in an online social network system. The token extractor extracts a plurality of tokens from title strings in the transition data. The transition data analyzer analyzes the transition data to generate a weight for each token in the plurality of tokens. A weight for a token in the plurality of tokens indicates a contribution of the token to a seniority rank of a title string that includes the token. The storing module stores the plurality of tokens and their associated weights in a database.

### TECHNICAL FIELD

This application relates to the technical fields of software and/or hardware technology and, in one example embodiment, to system and method to infer professional seniority of a member in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to infer professional seniority of a member may be implemented;

FIG. 2 is block diagram of a system to infer professional seniority of a member, in accordance with one example embodiment;

FIG. 3 is a flow chart of a method to infer professional seniority of a member, in accordance with an example embodiment;

FIG. 4 is a flow chart of a method to utilize inferred professional seniority of a member, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to infer professional seniority of a member in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method describe herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

Professional titles that appear in member profiles are not always descriptive enough to permit a clear assessment of the respective member's professional seniority. For example, the title “Senior Vice President of Products and User Experience” may be treated as associated with seniority level given to positions that deal with user experience, which are typically low seniority positions, while, in fact, this title may carry significant seniority a particular company or in a particular industry. In order to determine a seniority rank of a given professional title, method and system to infer professional seniority of a member in an on-line social network, in one example embodiment, may leverage so-called transition data, which is information that may be gleaned from a member profile with respect to the member's transition from one professional position to another. Transition data, for the purposes of this description, may be in the form of pairs of title strings, where each pair is also associated with a so-called label that indicates the direction of a transition signified by the pair. A pair of title strings and its associated label may be termed a transition pair. For example, a transition pair may include two title strings (e.g., “software developer” and “senior software developer”) and a label indicating that the chronological direction associated with the professional transition of the associated member is from a position identified by the title string “software developer” to the position identified by the title string “senior software developer.” Thus, a label in an associated transition pair indicates that one title string in the transition pair is indicative of a greater seniority rank than the other one title string in the transition pair.

In one embodiment, the method and system to infer professional seniority of a member employs a seniority standardization model (also termed merely a model for the purposes of this description) constructed to examine transition data from the member profiles maintained by the on-line social network and to determine how various words and phrases that may appear in the title strings affect professional seniority of a member represented by a profile that identifies the member as having a particular title. For example, the model may identify the word “senior” as having a significant positive effect on the seniority associated with the title string because in the majority of transition pairs where the word “senior” appears in one of the title strings, that title string is associated with a more recent position. Or, the model may identify the word “associate” as having a negative effect on the seniority associated with the title string because in the majority of transition pairs, where the word “senior” appears in one of the title strings, that title string is associated with a less recent position.

In operation, the system to infer professional seniority of a member extracts transition data from the member profiles maintained in the on-line social networking system. The system then identifies so-called tokens that, alone or in combination, may constitute a title string. A token is word or a phrase that may be included in a title string that is present in a member profile. Thus, the phrases “senior,” “associate,” “vice president,” “director,” etc. may all be considered as tokens for the purposes of this description. For example, from the title string “senior vice president” the model may generate the following tokens: “senior,” “vice,” “president,” “senior vice,” and “vice president.” In one embodiment, the tokens of lengths grater that 1 are formed from words that appear consecutively in the title string. The seniority standardization model may then analyze the transition data and the identified tokens to generate a weight for each token. The weight for a token indicates a contribution of the token to a seniority rank of a title string that includes the token.

The seniority rank of a title string may be determined as a sum of the weights of the tokens that constitute the title string. For example, if the weight assigned to the token “senior” is 5 and the weight assigned to the token “director” is 8, the seniority rank of the title string “Senior Director” may be calculated as the sum of the weight assigned to the token “senior” and the weight assigned to the token “director,” which adds up to 13. A token may also have a negative value. For example, if the weight assigned to the token “president” is 20 and the weight assigned to the token “vice” is (−5), the rank of the title string “Vice President” may be calculated as the sum of the weight assigned to the token “president” and the weight assigned to the token “vice,” which adds up to 15. A weight assigned to a token may also be a decimal number.

A seniority standardization model may utilize a plurality of rules. One of the rules employed by the model may be to infer that the more recent position in the employment history of a member is associated with a greater seniority, as compared to a less recent position. Another rule employed by the model may be to infer that position A has a greater seniority that position B, if the majority, if not all, transition pairs that include title strings A and B are associated with the label indicating that position A is chronologically more recent than position B. For example, the model may utilize a certain threshold (e.g., 80%) to establish relative seniority between two title strings. If the percentage of transition pairs—that include title strings A and B and have the associated labels indicating that position A is chronologically more recent than position B—is equal or greater than the threshold value, the title string representing position A is to be considered as associated with greater seniority than the title string representing position B.

In some embodiments, transition data used by a seniority standardization model may be selected based on the associated industry. For example, to determine seniority ranks for title strings that appear in the Internet industry, the transition data may be selected only from the member profiles associated with the Internet industry. To determine seniority ranks for title strings that appear in the banking industry, the transition data may be selected only from the member profiles associated with the banking industry. The model then determines the weights for various tokens with respect to that specific industry. Thus, the weight assigned to the token “principal” based on transition data associated with the Internet industry may be different from the weight assigned to the same token “principal” based on transition data associated with the banking industry.

In some embodiments, transition data used by a seniority standardization model may be selected based on the associated geographic location. For example, to determine seniority ranks for title strings that appear in member profiles representing members located in Europe, the transition data may be selected only from the member profiles indicating that the associated member or an employer referenced in the profile is located in Europe. The model then determines the weights for various tokens with respect to that specific geographic location. The tokens and their associated weights may be saved in a database and may be periodically updated to reflect changes in the universe of member profiles in the on-line social network system.

The system to infer professional seniority of a member may be configured to associate profiles in the on-line social network system with respective seniority ranks, based on the title string found in a given profile that represents the most recent professional position of the associated member. In one embodiment, if the title string found in a given profile that represents the most recent professional position of the associated member is obscure in a sense that no sufficient transition data is available with respect to that title string, the model may determine the seniority rank to be assigned to the profile based on a title string in the profile that represents a previously-held position. Examples of obscure title strings may include, e.g., “director of beta science” or “head of query understanding.”

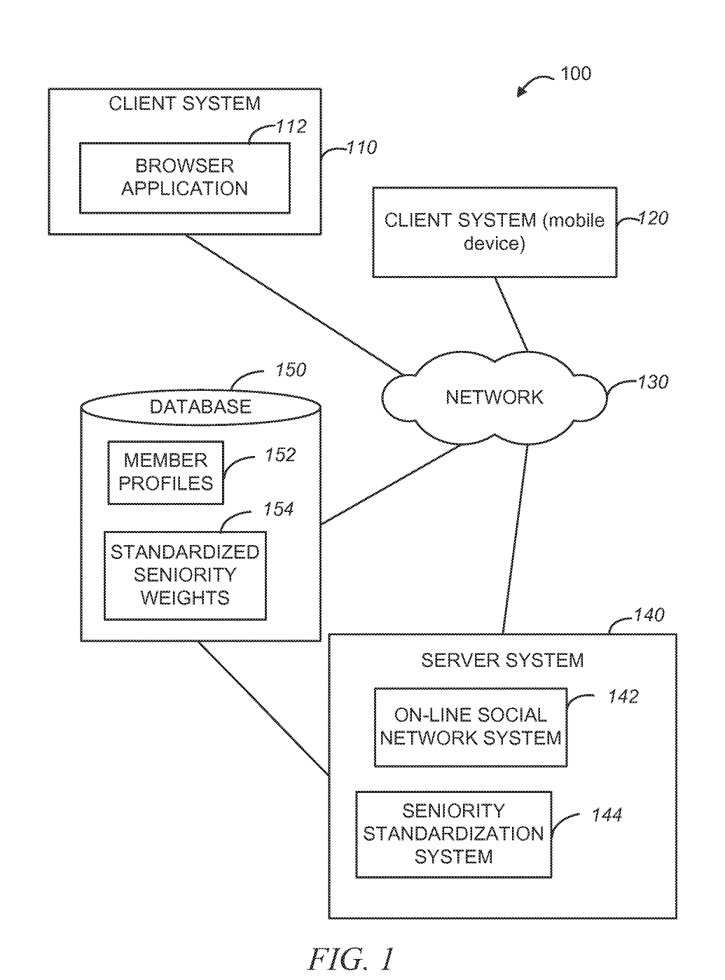

A seniority rank associated with a member profile may be used to match that profile with various job postings in the on-line social network. It may also be used by hiring managers that are looking to match professionals with available jobs. A seniority rank value may be included into a search query requested within the on-line social network system. Seniority rank information may also be used in ad targeting, such that, e.g., certain ads may be presented to members associated with a certain range of seniority ranks. Also, the charge per impression for an ad may be different based on the seniority rank of a member who is the target of the ad. For example, the charge per impression for an ad may be greater when it is presented on a news feed page of a member assigned a greater seniority rank. Example method and system to infer seniority of a member may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a seniority standardization system 144. The seniority standardization system 144 may be configured to derive, from member profiles 152 maintained in the on-line social networking system 142, weights for tokens that may appear in the title strings found in member profiles. The weights assigned to various tokens, which may be termed standardized seniority weights. The standardized seniority weights may be stored in the database 150 as standardized seniority weights 154. The seniority standardization system 144 may periodically update the standardized seniority weights 154.

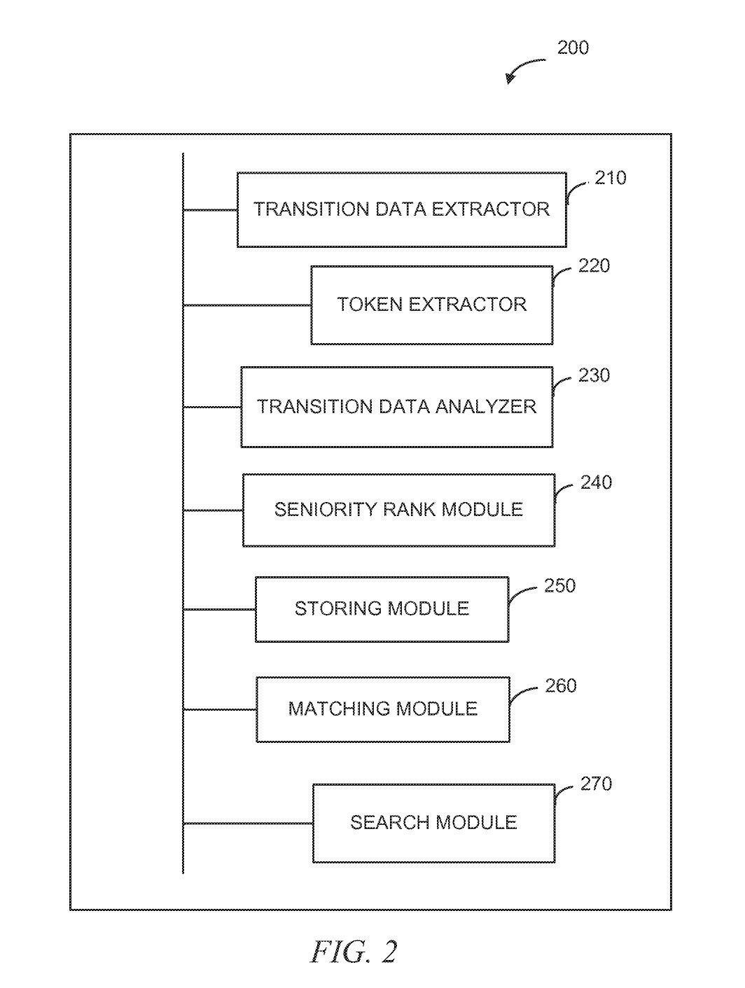

The seniority standardization system 144 may associate profiles in the on-line social network system with respective appropriate seniority rank, based on the title string indicating the current position of a member represented by a given profile. An identification of a job seniority associated with a profile may be used to match that profile with various job postings in the on-line social network 142. An example seniority standardization model 144 is illustrated in FIG. 2.

FIG. 2 is a block diagram of a system 200 to infer seniority level of a social network member, in accordance with one example embodiment. As shown in FIG. 2, the system 200 includes a transition data extractor 210, a token extractor 220, a transition data analyzer 230, and a storing module 240. The transition data extractor 210 may be configured to extract transition data from member profiles maintained in the on-line social network system 142 of FIG. 1. As explained above, a title string in a member profile represents a professional position of the associated member. An item of the transition data comprises a first title string associated with a first time period, a second title string associated with a second time period, and a label. The label indicates that the second title string in the transition pair has a greater seniority weight than the first title string in the transition pair. The token extractor 220 may be configured to extract a plurality of tokens from title strings in the transition data. A token comprises one or more consecutive words from a title string. The transition data analyzer 230 may be configured to analyze the transition data to generate a weight for each token in the plurality of tokens. A weight for a token in the plurality of tokens indicates a contribution of the token to a seniority rank of a title string that includes the token. A weight for a token may be represented by a positive or negative number. The transition data extractor 210 may also be configured to extract transition data from member profiles associated with a particular industry, such that a weight generated for a token extracted from a title string found in a member profile reflects contribution of the token to a seniority rank of a title string that includes the token with respect to that particular industry. The storing module 240 may be configured to store the plurality of tokens and their associated weights in the database 150 of FIG. 1.

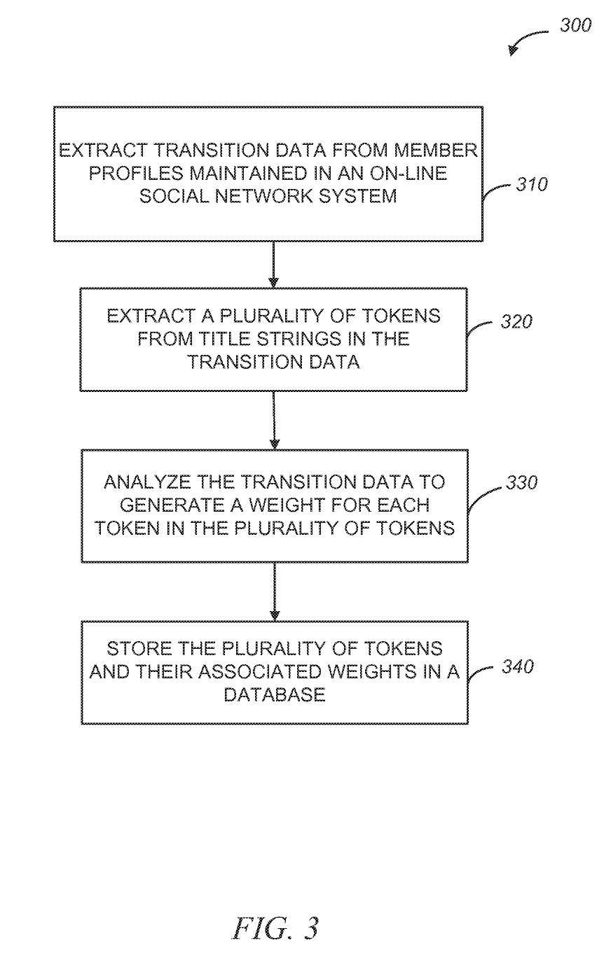

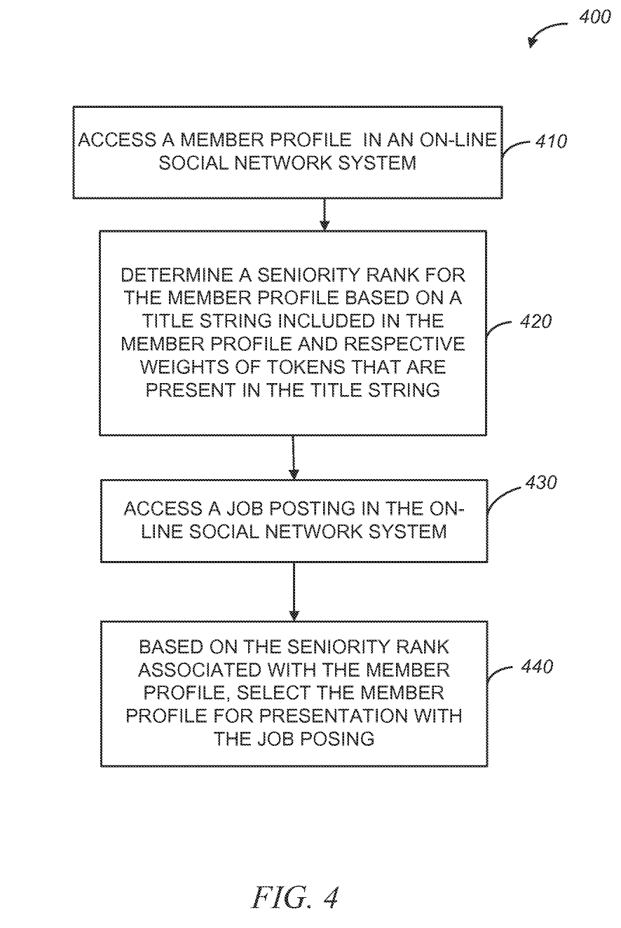

Also shown in FIG. 2 are a seniority rank module 250, a matching module 260, and a search module 270. The seniority rank module 250 may be configured to determine a seniority rank for a member profile based on a title string included in the member profile and respective weights of tokens from the plurality of tokens that are present in the title string. The seniority rank module 250 may calculate the seniority rank for a member profile as a sum of the respective weights of the tokens that are present in the title string found in the member profile. The matching module 260 may be configured to access a job posting in the on-line social network system and, based on a seniority rank associated with a profile from the member profiles, select the profile for presentation with the job posing. The matching module 260 may also access an ad in the on-line social network system and, based on a seniority rank associated with a profile from the member profiles, select the profile for presentation with the ad. The search module 270 may be configured to receive a search query in the on-line social network system, where the search query comprises a specified seniority rank, and retrieve one or more member profiles from the member profiles assigned the specified seniority rank. Some operations performed by the system 200 may be described with reference to FIG. 3 and FIG. 4.

FIG. 3 is a flow chart of a method 300 to infer seniority level of a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the transition data extractor 210 of FIG. 2 extracts transition data from member profiles maintained in the on-line social network system 142 of FIG. 1. At operation 320, the token extractor 220 of FIG. 2 extracts a plurality of tokens—one or more consecutive words from a title string—from title strings in the transition data. At operation 330, the transition data analyzer 230 of FIG. 2 analyzes the transition data to generate a weight for each token in the plurality of tokens, where a weight for a token indicates a contribution of the token to a seniority rank of a title string that includes the token. The transition data may be extracted from a particular group of member profiles, e.g., those profiles that are associated with a particular industry. The storing module 240 of FIG. 2 stores the plurality of tokens and their associated weights in the database 150 of FIG. 1, at operation 340.

FIG. 4 is a flow chart of a method 400 to utilize inferred professional seniority of a member, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 4, the method 400 commences at operation 410, when the matching module 260 of FIG. 2 accesses a member profile in the on-line social network system 142 of FIG. 1. At operation 420, the token extractor 220 of FIG. 2 extracts a plurality of tokens—one or more consecutive words from a title string—from the title string in the member profile and the seniority rank module 240 of FIG. 2 determines a seniority rank of the member profile based on a title string included in the member profile and respective weights of tokens that are present in the title string. As explained above, the seniority rank may be calculated as a sum of the respective weights of the tokens that are present in the title string. At operation 430, the matching module 260 of FIG. 2 accesses a job posting in the on-line social network system 142 of FIG. 1. At operation 440, the matching module 260 of FIG. 2 selects the profile for presentation with the job posing based on the seniority rank associated with the profile.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

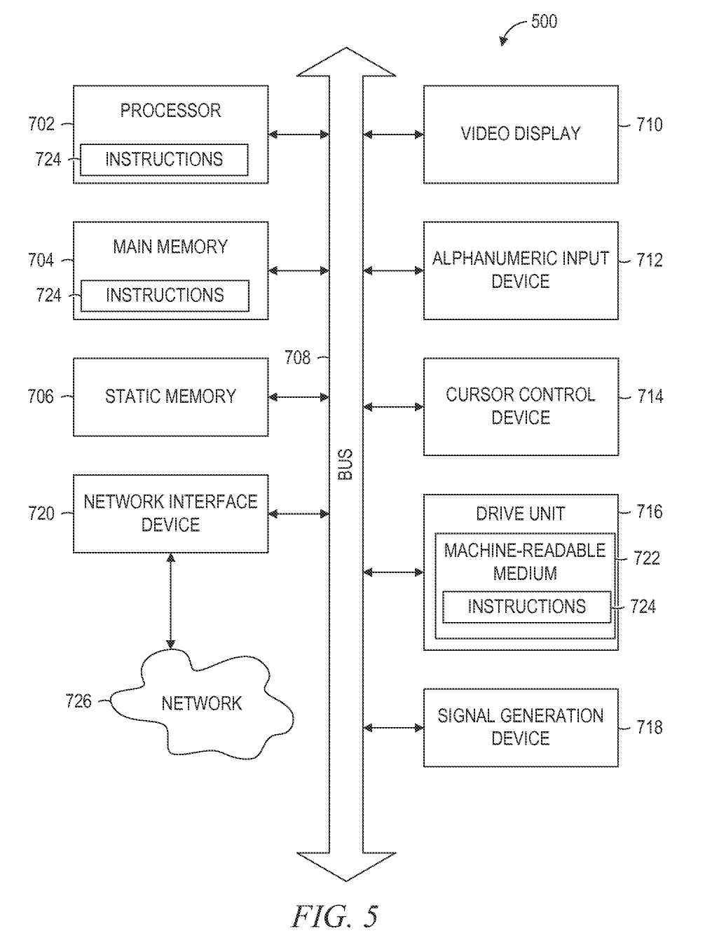

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media, Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system for standardizing professional seniority of members in an on-line social network system have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
extracting transition data from member profiles maintained in an on-line social network system, a title string in a member profile from the member profiles representing a professional position of a member represented by the member profile, an item of the transition data comprising a first title string associated with a first time period, a second title string associated with a second time period, and a label, the label indicating that the second title string in the transition pair has a greater seniority weight than the first title string in the transition pair;
from title strings in the transition data, extracting a plurality of tokens, a token from the plurality of tokens comprising one or more consecutive words from a title string from the plurality of title strings;
analyzing the transition data to generate, using at least one processor, a weight for each token in the plurality of tokens, a weight for a token in the plurality of tokens indicating a contribution of the token to a seniority rank of a title string that includes the token; and
storing the plurality of tokens and their associated weights in a database.

2. The method of claim 1, wherein the extracting of the transition data comprises:
from the member profiles, extracting title strings, a title string identifying a current professional position of a member represented by the profile; and
from the same profile, extracting a further title string, the further title string representing a previous position of the member represented by the profile.

3. The method of claim 1, comprising determining a seniority rank for a member profile based on a title string included in the member profile and respective weights of tokens from the plurality of tokens that are present in the title string.

4. The method of claim 3, wherein the determining of the seniority rank for the member profile comprises calculating the seniority rank as a sum of the respective weights of the tokens that are present in the title string.

5. The method of claim 3, comprising:
accessing a job posting in the on-line social network system; and
based on a seniority rank associated with a profile from the member profiles, selecting the profile for presentation with the job posing.

6. The method of claim 1, comprising:
receiving a search query in the on-line social network system, the search query comprising a specified seniority rank; and
retrieving one or more member profiles from the member profiles assigned the specified seniority rank.

7. The method of claim 1, comprising:
accessing an ad in the on-line social network system; and
based on a seniority rank associated with a profile from the member profiles, selecting the profile for presentation with the ad.

8. The method of claim 1, wherein a weight for a token from the plurality of tokens is represented by a positive or negative number.

9. The method of claim 1, wherein the extracting of the transition data from the member profiles comprises extracting the transition data from the member profiles associated with a particular industry.

10. The method of claim 1, wherein the extracting of the transition data from the member profiles comprises extracting the transition data from the member profiles associated with a particular geographic location.

11. A computer-implemented system comprising:
a transition data extractor, implemented using at least one processor, to extract transition data from member profiles maintained in an on-line social network system, a title string in a member profile from the member profiles representing a professional position of a member represented by the member profile, an item of the transition data comprising a first title string associated with a first time period, a second title string associated with a second time period, and a label, the label indicating that the second title string in the transition pair has a greater seniority weight than the first title string in the transition pair;
a token extractor, implemented using at least one processor, to extract a plurality of tokens from title strings in the transition data, a token from the plurality of tokens comprising one or more consecutive words from a title string from the plurality of title strings;
a transition data analyzer, implemented using at least one processor, to analyze the transition data to generate a weight for each token in the plurality of tokens, a weight for a token in the plurality of tokens indicating a contribution of the token to a seniority rank of a title string that includes the token; and
a storing module, implemented using at least one processor, to store the plurality of tokens and their associated weights in a database.

12. The system of claim 11, wherein the transition data extractor is to:
extract title strings from the member profiles, a title string identifying a current professional position of a member represented by the profile; and
extract a further title string from the same profile, the further title string representing a previous position of the member represented by the profile.

13. The system of claim 11, comprising a seniority rank module, implemented using at least one processor, to determine a seniority rank for a member profile based on a title string included in the member profile and respective weights of tokens from the plurality of tokens that are present in the title string.

14. The system of claim 13, wherein the seniority rank module is to calculate the seniority rank as a sum of the respective weights of the tokens that are present in the title string.

15. The system of claim 13, comprising a matching module, implemented using at least one processor, to:
access a job posting in the on-line social network system; and
based on a seniority rank associated with a profile from the member profiles, select the profile for presentation with the job posing.

16. The system of claim 11, comprising a search module, implemented using at least one processor, to:
receive a search query in the on-line social network system, the search query comprising a specified seniority rank; and
retrieve one or more member profiles from the member profiles assigned the specified seniority rank.

17. The system of claim 11, comprising a matching module, implemented using at least one processor, to:
access an ad in the on-line social network system; and
based on a seniority rank associated with a profile from the member profiles, select the profile for presentation with the ad.

18. The system of claim 11, wherein a weight for a token from the plurality of tokens is represented by a positive or negative number.

19. The system of claim 11, wherein the transition data extractor is to extract the transition data from the member profiles associated with a particular industry.

20. A machine-readable non-transitory storage medium having instruction data to cause a machine to perform operations comprising:
extracting transition data from member profiles maintained in an on-line social network system, a title string in a member profile from the member profiles representing a professional position of a member represented by the member profile, an item of the transition data comprising a first title string associated with a first time period, a second title string associated with a second time period, and a label, the label indicating that the second title string in the transition pair has a greater seniority weight than the first title string in the transition pair;
from title strings in the transition data, extracting a plurality of tokens, a token from the plurality of tokens comprising one or more consecutive words from a title string from the plurality of title strings;
analyzing the transition data to generate a weight for each token in the plurality of tokens, a weight for a token in the plurality of tokens indicating a contribution of the token to a seniority rank of a title string that includes the token; and
storing the plurality of tokens and their associated weights in a database.
